(19) United States
(12) Patent Application Publication
(10) Pub. No.: US 2019/0081480 A1
(43) Pub. Date: Mar. 14, 2019

(54) CLEAN-ENERGY POWER SUPPLY SYSTEM

(71) Applicant: CHUNG-HSIN ELECTRIC & MACHINERY MFG. CORP., Taoyuan City (TW)

(72) Inventors: Ting-Kuan LI, Taoyuan City (TW); Syuan-Yi LIN, Taoyuan City (TW); Sung-Feng TSAI, Taoyuan City (TW); Wen-Chieh WANG, Taoyuan City (TW); Yen-Haw CHEN, Taipei City (TW); Su-Ying LU, Taipei City (TW)

(21) Appl. No.: 15/984,299

(22) Filed: May 18, 2018

(30) Foreign Application Priority Data
Sep. 12, 2017 (TW) 106131210

(51) Int. Cl. H02J 3/16; H02J 7/00

(52) U.S. Cl. CPC H02J 3/16; H02J 3/387; H02J 7/0068

(57) ABSTRACT

A clean-energy power supply system is coupled between a power supply and a load. A first power generation device is configured to provide a renewable voltage. A power transformation device transforms the renewable voltage according to a first selection signal to generate a first transformed voltage or a second transformed voltage. A switch selectively transmits the first transformed voltage and the external voltage provided by the power supply to the load or transmits the second transformed voltage to the load. When the external voltage is not less than a predetermined value, the power transformation device generates the first transformed voltage and the switch transmits the first transformed voltage and the external voltage. When the external voltage is less than the predetermined value, the power transformation device stops generating the first transformed voltage and generates the second transformed voltage and the switch transmits the second transformed voltage.

### CROSS REFERENCE TO RELATED APPLICATIONS

This Application claims priority of Taiwan Patent Application No. 106131210, filed on Sep. 12, 2017, the entirety of which is incorporated by reference herein.

### BACKGROUND OF THE INVENTION

### Field of the Invention

The invention relates to a power supply, and more particularly to a power supply providing clean-energy.

### Description of the Related Art

Generally, a power supply system provides a voltage to a load via a power grid. However, when the power supply system cannot normally generate the voltage (e.g. due to a power trip or power failure), the power grid cannot transmit the voltage to the load. Therefore, the load cannot operate normally. If the load is an important device, such as a base station or a fileserver, it is impossible to transmit information when the load cannot operate normally.

### BRIEF SUMMARY OF THE INVENTION

In accordance with an embodiment, a clean-energy power supply system is coupled between a power supply and a load and comprises a first power generation device, a power transformation device, a switch and an energy management controller. The first power generation device is configured to provide a renewable voltage. The power transformation device transforms the renewable voltage according to a first selection signal to generate a first transformed voltage or a second transformed voltage and comprises a first output terminal and a second output terminal. The first output terminal is configured to output the first transformed voltage to a point of common coupling. The power supply outputs an external voltage to the point of common coupling. The second output terminal is configured to output the second transformed voltage. The switch selectively transmits the voltage of the point of common coupling to the load or transmits the second transformed voltage to the load according to a second selection signal. The energy management controller generates the first and second selection signals according to the external voltage. When the external voltage is not less than a first predetermined value, the power transformation device generates the first transformed voltage. When the external voltage is less than the first predetermined value, the power transformation device stops generating the first transformed voltage and generates the second transformed voltage and the switch transmits the second transformed voltage to the load.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a clean-energy power supply system, according to various aspects of the present disclosure.

FIG. 2 is a schematic diagram of another exemplary embodiment of the clean-energy power supply system, according to various aspects of the present disclosure.

FIG. 3 is a schematic diagram of another exemplary embodiment of the clean-energy power supply system, according to various aspects of the present disclosure.

FIG. 4 is a schematic diagram of another exemplary embodiment of the clean-energy power supply system, according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

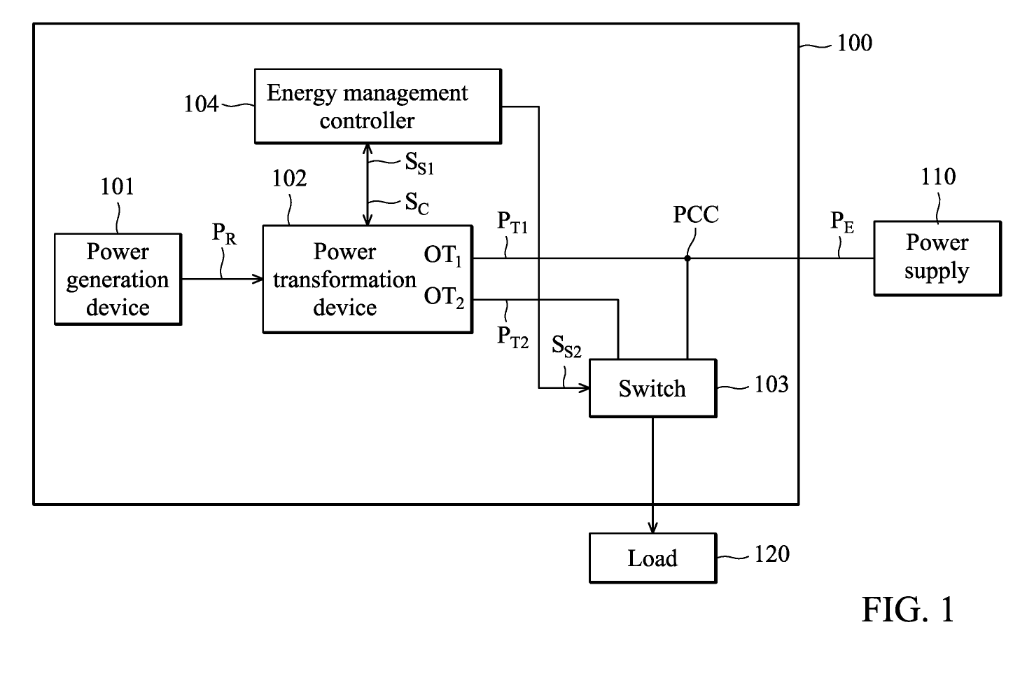

FIG. 1 is a schematic diagram of an exemplary embodiment of a clean-energy power supply system, according to various aspects of the present disclosure. The clean-energy power supply system 100 is coupled between a power supply 110 and a load 120. The clean-energy power supply system 100 is coupled to the power supply 110 in parallel. The clean-energy power supply system 100 and the power supply 110 provide voltages to the load 120 together. When the voltage provided by the power supply 110 is unstable or the power supply 110 stops providing the voltage to the load 120, the clean-energy power supply system 100 alone provides the voltage to the load 120. The kind of power supply 110 is not limited in the present disclosure. In one embodiment, the power supply 110 is an alternating current (AC) power grid. In another embodiment, the power supply 110 is a diesel generator or a city power grid. In other embodiments, the output power provided by the power supply 110 is less than 1 MW.

In this embodiment, the clean-energy power supply system 100 comprises a power generation device 101, a power transformation device 102, a switch 103 and an energy management controller 104. The power generation device 101 is configured to provide a renewable voltage P_{R}. In one embodiment, the renewable voltage P_{R} is DC power. The kind of power generation device 101 is not limited in the present disclosure. In one embodiment, the power generation device 101 may be a solar panel, a wind turbine generator, or a hydroelectric generator.

The power transformation device 102 transforms the renewable voltage P_{R} according to a selection signal S_{S1} to generate transformed voltage P_{T1} or P_{T2}. In this embodiment, the power transformation device 102 comprises output terminals OT₁ and OT₂. The output terminal OT₁ is configured to output the transformed voltage P_{T1} to a point of common coupling. The output terminal OT₂ is configured to output the transformed voltage P_{T2} to the switch 103. In one embodiment, the transformed voltage P_{T1} is AC power and the transformed voltage P_{T2} is also AC power, but the disclosure is not limited thereto. In other embodiments, at least one of the transformed voltages P_{T1} and P_{T2} is a DC voltage.

In the present disclosure, the kind of power transformation device 102 is not limited. In one embodiment, the power transformation device 102 transforms the format of the voltage from a DC format to an AC format. In another embodiment, the power transformation device 102 is a DC-DC converter. In some embodiments, the power transformation device 102 is an AC-AC cycle converter. In other embodiments, the power transformation device 102 is an inverter. In this embodiment, the power supply 110 also provides an external voltage P_{E} to the point of common coupling PCC.

The switch 103 is coupled to the power transformation device 102, the point of common coupling PCC and the load 120. In this embodiment, the switch 103 selectively transmits the voltage at the point of common coupling PCC to the load 120 or transmits the transformed voltage P_{T2} to the load 120 according to a selection signal S_{S2}. In one embodiment, when the power supply 110 provides voltage normally, the switch 103 transmits the voltage at the point of common coupling PCC to the load 120. However, when the power supply 110 is very difficult to provide voltage normally, the switch 103 transmits the transformed voltage P_{T2} to the load 120.

The energy management controller 104 generates the selection signals S_{S1} and S_{S2} according to the external voltage P_{E}. In this embodiment, the energy management controller 104 utilizes the power transformation device 102 to detect the external voltage P_{E}. In other embodiments, the energy management controller 104 directly detects the external voltage P_{E}. When the external voltage P_{E} is not less than a first predetermined value, it means that the power supply 110 provides the voltage normally. Therefore, the clean-energy power supply system 100 enters a grid-tied mode. In the grid-tied mode, the power transformation device 102 generates the transformed voltage P_{T1} and the switch 103 transmits the voltage at the point of common coupling PCC to the load 120. However, when the external voltage P_{E} is less than the first predetermined value, it means that the power supply 110 is impossible to output the voltage normally. Therefore, the clean-energy power supply system 100 enters an off-grid mode. In the off-grid mode, the power transformation device 102 stops generating the transformed voltage P_{T1} and starts generating the transformed voltage P_{T2}. In this case, the switch 103 transmits the transformed voltage P_{T2} to the load 120.

In other embodiments, in the grid-tied mode, the energy management controller 104 utilizes the power transformation device 102 to detect the voltage of the point of common coupling PCC and generate a control signal S_{C} according to the voltage of point of common coupling PCC. The power transformation device 102 adjusts the transformed voltage P_{T1} according to the control signal S_{C} to maintain the voltage of the point of common coupling PCC. Therefore, the clean-energy power supply system is able to stabilize the voltage at the point of common coupling PCC and increase the quality of the voltage at the point of common coupling PCC.

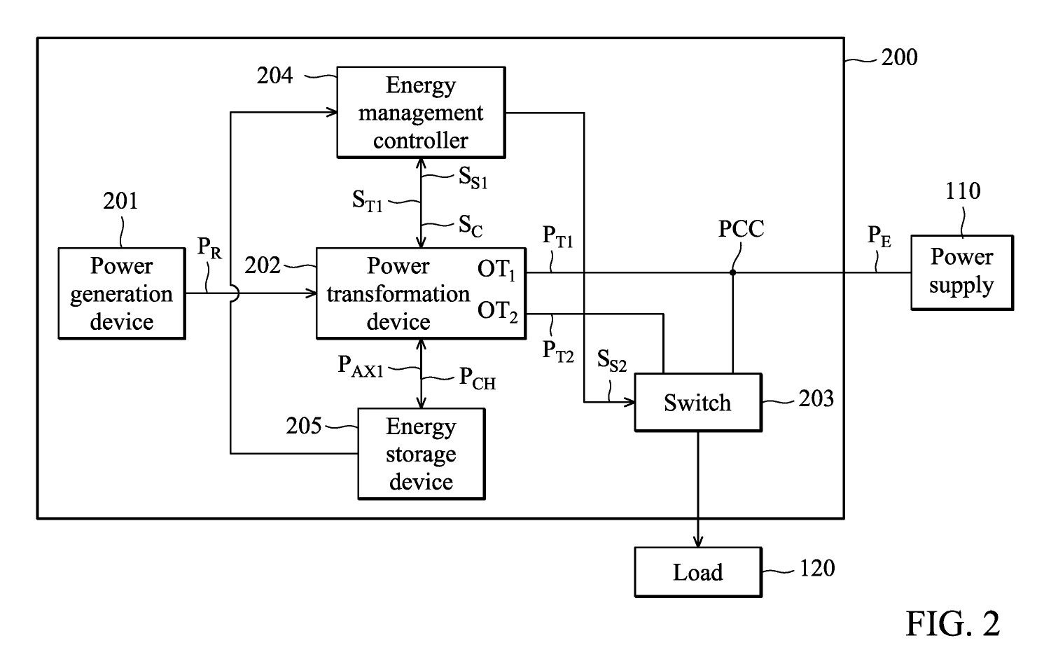

FIG. 2 is a schematic diagram of another exemplary embodiment of the clean-energy power supply system, according to various aspects of the present disclosure. FIG. 2 is similar to FIG. 1 except that the clean-energy power supply system 200 in FIG. 2 further comprises an energy storage device 205. Since the features of the power generation device 201, the power transformation device 202, and the switch 203 are respectively the same as the features of the power generation device 101, the power transformation device 102, and the switch 103, the descriptions of the features of the power generation device 201, the power transformation device 202, and the switch 203 are omitted.

In this embodiment, when the renewable voltage P_{R} is higher than a second predetermined value, it means that the renewable voltage P_{R} is capable of driving the load 120. Therefore, the power transformation device 202 generates a charging voltage P_{CH} to the energy storage device 205 according to the renewable voltage P_{R} to charge the energy storage device 205. However, when the renewable voltage P_{R} is less than a third predetermined value, it means that the renewable voltage P_{R} cannot drive the load 120. Therefore, the power transformation device 202 extracts an auxiliary voltage P_{AX1} from the energy storage device 205 and generates the transformed voltage P_{T1} or P_{T2} according to the renewable voltage P_{R} and the auxiliary voltage P_{AX1}.

In one embodiment, the energy management controller 204 utilizes the power transformation device 202 to detect the renewable voltage P_{R} to generate a detection result and generate a trigger signal S_{T1} to the power transformation device 202 according to the detection result. The power transformation device 202 charges the energy storage device 205 or extracts the auxiliary voltage P_{AX1} from the energy storage device 205 according to the trigger signal S_{T1}. In other embodiments, the energy management controller 204 is directly coupled to the power generation device 201 to directly detect the renewable voltage P_{R}.

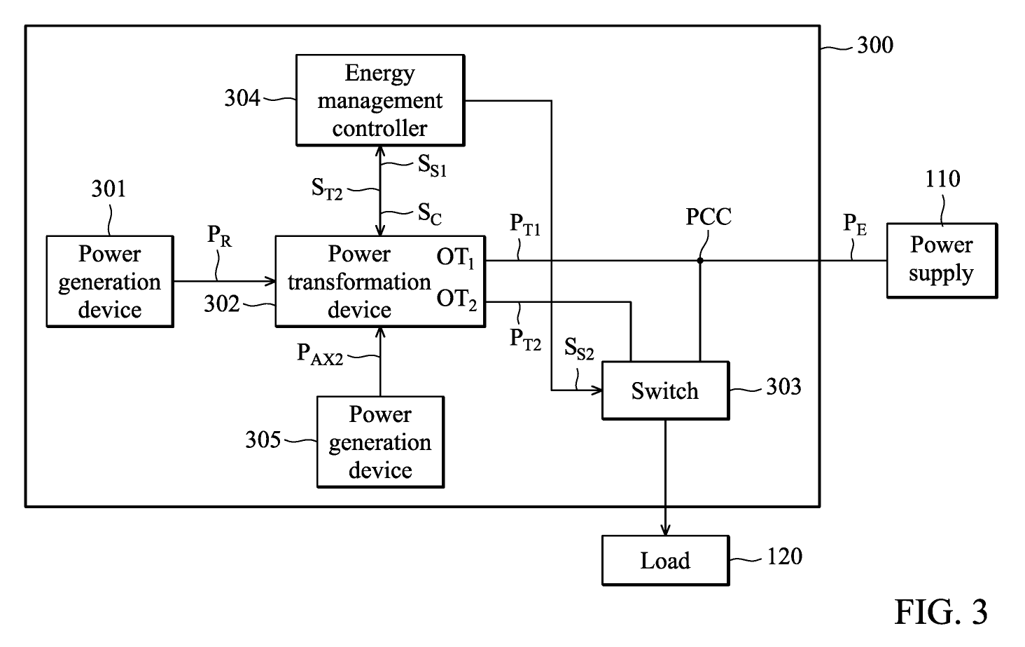

FIG. 3 is a schematic diagram of another exemplary embodiment of the clean-energy power supply system, according to various aspects of the present disclosure. FIG. 3 is similar to FIG. 1 with the exception that the clean-energy power supply system shown in FIG. 3 further comprises a power generation device 305. Since the features of the power generation device 301, the power transformation device 302, and the switch 303 shown in FIG. 3 are respectively the same as the features of the power generation device 101, the power transformation device 102, and the switch 103 shown in FIG. 1, the descriptions of the features of the power generation device 301, the power transformation device 302, and the switch 303 are omitted.

When the renewable voltage P_{R} is less than the third predetermined value, it means that the renewable voltage P_{R} is not capable of driving the load 120. Therefore, the energy management controller 304 generates a trigger signal S_{T2}. The power transformation device 302 activates the power generation device 305 according to the trigger signal S_{T2}. At this time, the power generation device 305 generates an auxiliary voltage P_{AX2}. The power transformation device 302 receives the auxiliary voltage P_{AX2} and generates the transformed voltage P_{T1} or P_{T2} according to the renewable voltage P_{R} and the auxiliary voltage P_{AX2}. In one embodiment, the power generation device 305 is a clean-energy power generator to generate clean power, without polluting the environment. For example, the power generation device 305 may be a fuel cell, a wind turbine generator, or a solar panel.

In one embodiment, the energy management controller 304 detects the renewable voltage P_{R} via the power transformation device 302 to generate a detection result and then generate the trigger signal S_{T2} according to the detection result. In other embodiments, the energy management controller 304 is directly coupled to the power generation device 301 to directly detect the renewable voltage P_{R}.

In some embodiments, the power generation device 305 is combined within the clean-energy power supply system 200. In this case, when the renewable voltage P_{R} is lower, the energy management controller 204 sends the trigger signals S_{T1} and S_{T2}. Therefore, the power transformation device 202 generates the transformed voltage P_{T1} or P_{T2} according to the renewable voltage P_{R} generated by the power generation device 201, the auxiliary voltage P_{AX1} extracted from the energy storage device 205 and the auxiliary voltage P_{AX2} generated from the power generation device 305.

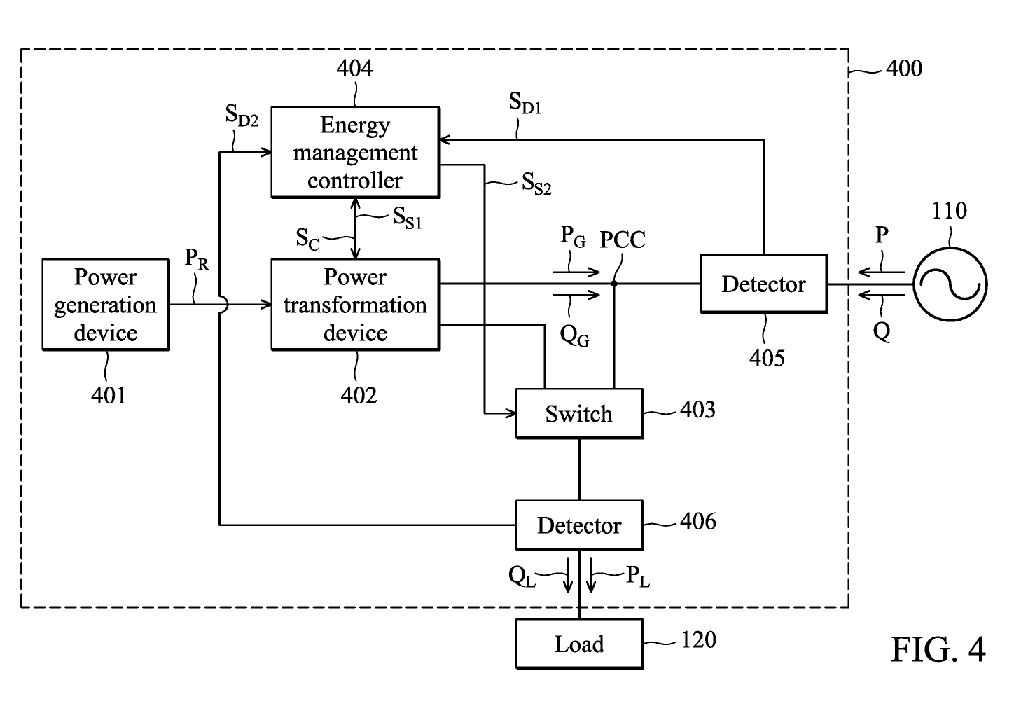

FIG. 4 is a schematic diagram of another exemplary embodiment of the clean-energy power supply system, according to various aspects of the present disclosure. FIG. 4 is similar to FIG. 1 except that the clean-energy power supply system 400 shown in FIG. 4 further comprises detectors 405 and 406. Since the features of the power generation device 401, the power transformation device 402, and the switch 403 shown in FIG. 4 are respectively the same as the features of the power generation device 101, the power transformation device 102, and the switch 103 shown in FIG. 1, the descriptions of the features of the power generation device 401, the power transformation device 402, and the switch 403 are omitted.

The detector 405 is coupled to the power transformation device 402 and the power supply 110 and detects the real power P and the reactive power Q of the voltage output from the power supply 110 to generate a detection signal S_{D1}. To measure the real power P and the reactive power Q of the power supply 110, the detector 405 is disposed close to the power supply 110.

The detector 406 is coupled between the switch 403 and the load 120 and detects the real power P_{L} and the reactive power Q_{L} of the load 120 to generate a detection signal S_{D2}. In one embodiment, the detector 406 is disposed near the load 120. The energy management controller 404 generates a control signal S_{C} according to the detection signals S_{D1} and S_{D2}. The power transformation device 402 adjusts and outputs the real power P_{G} and the reactive power Q_{G} according to the control signal S_{C}. For example, when the real power P_{L} of the load 120 is increased, the power transformation device 402 increases the real power P_{G}. However, when the real power P_{L} of the load 120 is reduced, the power transformation device 402 reduces the real power P_{G}. In other embodiments, when the reactive power Q_{L} of the load 120 is increased, the power transformation device 402 increases the reactive power Q_{G}. However, when the reactive power Q_{L} of the load 120 is reduced, the power transformation device 402 reduces the reactive power Q_{G}.

For example, assume that the real power P_{L} of the load 120 is 5 W and the reactive power Q_{L} of the load 120 is 2V Ar. The sum of the real power P_{G} output from the power transformation device 402 and the real power P output from the power supply 110 is 5 W. Additionally, the sum of the reactive power Q_{G} output from the power transformation device 402 and the reactive power Q output from the power supply 110 is 2V Ar. In this case, when the real power P_{L} of the load 120 is increased from 5 W to 7 W and the reactive power Q_{L} of the load 120 is increased from 2V Ar to 4V Ar, the real power P_{G} output from the power transformation device 402 is increased by 2 W and the reactive power Q_{G} output from the power transformation device 402 is increased by 2V Ar to match up the requirement of the load 120 and maintain the real power P and the reactive power Q output from the power supply 110. Since the variations in the real power P_{G} and the reactive power Q_{G} output by the power transformation device 402 follow the variations in the real power P_{L} and the reactive power Q_{L} of the load 120, the real power P and the reactive power Q output by the power supply 110 are not interfered with by variations in the real power P_{L} and the reactive power Q_{L} output by the load 120. When the real power P and the reactive power Q output by the power supply 110 are fixed, the voltage of the point of common coupling PCC is stabilized.

The present disclosure does not limit how the power of the load 120 is detected. In one embodiment, the detector 406 detects the voltage and the current of the load 120 during a predetermined period. In this case, the energy management controller 404 obtains a voltage curve and a current curve of the load 120 in the predetermined period according to the detection results generated from the detector 406. The energy management controller 404 generates the control signal S_{C} according to the voltage curve and the current curve.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

What is claimed is:

1. A clean-energy power supply system coupled between a power supply and a load, comprising:
a first power generation device configured to provide a renewable voltage;
a power transformation device transforming the renewable voltage according to a first selection signal to generate a first transformed voltage or a second transformed voltage and comprising:
a first output terminal configured to output the first transformed voltage to a point of common coupling, wherein the power supply outputs an external voltage to the point of common coupling; and
a second output terminal configured to output the second transformed voltage;
a switch selectively transmitting the voltage of the point of common coupling to the load or transmitting the second transformed voltage to the load according to a second selection signal; and
an energy management controller generating the first and second selection signals according to the external voltage, wherein when the external voltage is not less than a first predetermined value, the power transformation device generates the first transformed voltage, and when the external voltage is less than the first predetermined value, the power transformation device stops generating the first transformed voltage and generates the second transformed voltage and the switch transmits the second transformed voltage to the load.

2. The clean-energy power supply system as claimed in claim 1, wherein the energy management controller generates a first control signal according to the voltage at the point of common coupling, and the power transformation device adjusts the first transformed voltage to adjust the voltage of the point of common coupling according to the first control signal.

3. The clean-energy power supply system as claimed in claim 2, further comprising:
a first detector coupled between the power transformation device and the power supply and detecting a first real power and a first reactive power to generate a first detection signal, wherein the energy management controller generates the first control signal according to the first detection signal.

4. The clean-energy power supply system as claimed in claim 1, wherein the energy management controller generates a second control signal according to a second real power of the load and a second reactive power of the load, and the power transformation device adjusts and outputs a third real power and a third reactive power according to the second control signal.

5. The clean-energy power supply system as claimed in claim 4, further comprising:
a second detector coupled between the switch and the load and detecting the second real power and the second reactive power to generate a second detection signal, wherein the energy management controller generates the second control signal according to the second detection signal.

6. The clean-energy power supply system as claimed in claim 4, wherein when the second real power is increased, the power transformation device increases the third real power, and when the second real power is reduced, the power transformation device reduces the third real power.

7. The clean-energy power supply system as claimed in claim 4, wherein when the second reactive power is increased, the power transformation device increases the third reactive power, and when the second reactive power is reduced, the power transformation device reduces the third reactive power.

8. The clean-energy power supply system as claimed in claim 1, further comprising:
an energy storage device coupled to the power transformation device, wherein when the renewable voltage is higher than a second predetermined value, the power transformation device charges the energy storage device according to the renewable voltage.

9. The clean-energy power supply system as claimed in claim 8, wherein when the renewable voltage is less than a third predetermined value, the power transformation device extracts a first auxiliary voltage from the energy storage device and generates the first or second transformed voltage according to the renewable voltage and the first auxiliary voltage.

10. The clean-energy power supply system as claimed in claim 9, further comprising:
a second power generation device configured to provide a second auxiliary voltage, wherein the power transformation device generates the first or second transformed voltage according to the renewable voltage and the first and second auxiliary voltages.

11. The clean-energy power supply system as claimed in claim 10, wherein the second power generation device is a fuel cell, a wind turbine generator or a solar panel.

12. The clean-energy power supply system as claimed in claim 1, wherein the renewable voltage is a direct current (DC) power, and the first transformed voltage is an alternating current (AC) power.

13. The clean-energy power supply system as claimed in claim 1, wherein output power of the power supply is less than 1 MW.

14. The clean-energy power supply system as claimed in claim 1, wherein the first power generation device is a solar panel, a wind turbine generator or a hydroelectric generator.

15. The clean-energy power supply system as claimed in claim 1, wherein the power transformation device is an inverter.

16. The clean-energy power supply system as claimed in claim 1, wherein output power of the power supply is not interfered with by a variation in the power of the load.

17. The clean-energy power supply system as claimed in claim 1, wherein the power supply is a diesel generator.

18. The clean-energy power supply system as claimed in claim 1, wherein the energy management controller obtains a voltage curve and a current curve of the load according to the voltage of the load during a predetermined period and the current of the load during the predetermined period, and the energy management controller controls the power transformation device according to the voltage curve and the current curve to adjust the first transformed voltage.
